(19) United States
(12) Patent Application Publication
(10) Pub. No.: US 2022/0001418 A1
(43) Pub. Date: Jan. 6, 2022

(54) LENS DYEING METHOD, AND LENS ASSEMBLY MANUFACTURING METHOD

(71) Applicant: Samsung Electro-Mechanics Co., Ltd., Suwon-si (KR)

(72) Inventors: Seong Chan PARK, Suwon-si (KR); Ae Rim KIM, Suwon-si (KR); Sang Hyun KWON, Suwon-si (KR); Sang Hyeon HONG, Suwon-si (KR); Choon Keun LEE, Suwon-si (KR)

(73) Assignee: Samsung Electro-Mechanics Co., Ltd., Suwon-si (KR)

(21) Appl. No.: 17/163,915

(22) Filed: Feb. 1, 2021

(30) Foreign Application Priority Data
Jul. 2, 2020 (KR) 10-2020-0081722

(51) Int. Cl. B05D 1/18; B05D 3/02

(52) U.S. Cl. CPC B05D 1/18; G02B 13/18; B05D 3/0254

(57) ABSTRACT

A method of dyeing a lens, and a method of manufacturing a lens assembly is provided. The method includes an operation of dipping the lens in a dyeing solution containing a non-polar dye.

### CROSS-REFERENCE TO RELATED APPLICATION(S)

This application claims the benefit under 35 USC § 119(a) of priority to Korean Patent Application No. 10-2020-0081722 filed on Jul. 2, 2020, in the Korean Intellectual Property Office, the entire disclosure of which is incorporated herein by reference for all purposes.

### BACKGROUND

### 1. Field

The following description relates to a lens dyeing method, and a lens assembly manufacturing method.

### 2. Description of Related Art

In a lens assembly that is implemented in a camera module, or similar module, when strong or intensive light from a fluorescent lamp, or light in a dark room is incident at a certain angle, a problem may occur in which light at a specific angle may cause internal reflection from a rib surface of the lens. Such light is light that is not related to image formation, which causes flare or ghost phenomenon on a screen. Therefore, it may be beneficial to block the incidence of unnecessary light from the rib surface of the lens.

The above information disclosed in this Background section is only for enhancement of understanding of the background of the described technology, and therefore it may contain information that does not form the prior art that is already known in this country to a person of ordinary skill in the art.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a method of dyeing a lens includes dipping one or more lens in a dyeing solution containing a non-polar dye.

The non-polar dye may include a non-polar anthraquinone-based dye.

The one or more lens may include at least one raw material selected from a polycarbonate resin and a polyolefin resin.

The dyeing solution further may include a solvent that dissolves the non-polar dye, wherein the solvent may further include at least one of benzene, toluene and chloroform.

A content of the non-polar dye for the solvent may be 0.1 or more and 5 or less by weight %.

The dipping of the lens in the dyeing solution containing the non-polar dye may be performed at a temperature of 60° C. or lower.

The dipping of the lens in the dyeing solution containing the non-polar dye may be performed for a time of 30 seconds or less.

The method may further include an operation of drying the lens.

The non-polar anthraquinone-based dye may include three or less amine groups.

In a general aspect, a method of manufacturing a lens assembly includes forming a blocking portion by dipping each of a plurality of lenses in a dyeing solution containing a non-polar dye; and stacking the plurality of lenses.

In the forming of the blocking portion by dipping each of the plurality of lenses in the dyeing solution containing the non-polar dye, the blocking portion may be formed on a rib surface of each of the plurality of lenses, and in the stacking of the plurality of lenses, the rib surface of each of the lenses, adjacent to each other, may be in contact with each other.

In the stacking of the plurality of lenses, the plurality of lenses may be stacked in an internal space of a lens barrel such that each of the plurality of lenses is in contact with an inner circumferential surface of the lens barrel, and in the forming of the blocking portion by dipping each of the plurality of lenses in the dyeing solution containing the non-polar dye, the blocking portion may be further formed on a surface of each of the plurality of lenses, in contact with the inner circumferential surface of the lens barrel.

The non-polar dye may include a non-polar anthraquinone-based dye.

The lens may include at least one raw material selected from a polycarbonate resin and a polyolefin resin.

The dyeing solution may further include a solvent that dissolves the non-polar dye, and the solvent may further include at least one of benzene, toluene and chloroform.

The non-polar anthraquinone-based dye may include 3 or less amine groups.

Other features and aspects will be apparent from the following detailed description, the drawings, and the claims.

### BRIEF DESCRIPTION OF DRAWINGS

FIG. 1 is a flowchart schematically illustrating an example method of dyeing a lens, in accordance with one or more embodiments;

FIG. 2 is a graph illustrating light transmittance of an example lens dyed according to each of the Examples and Comparative Examples of the examples with respect to a wavelength of light, in accordance with one or more embodiments;

FIG. 3 is a flowchart schematically illustrating an example method of manufacturing a lens assembly, in accordance with one or more embodiments; and

FIG. 4 is a schematic cross-sectional view of an example lens assembly manufactured, in accordance with one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness, noting that omissions of features and their descriptions are also not intended to be admissions of their general knowledge.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains and after an understanding of the disclosure of this application. Terms, such as those defined in commonly used dictionaries, are to be interpreted as having a meaning that is consistent with their meaning in the context of the relevant art and the disclosure of this application, and are not to be interpreted in an idealized or overly formal sense unless expressly so defined herein.

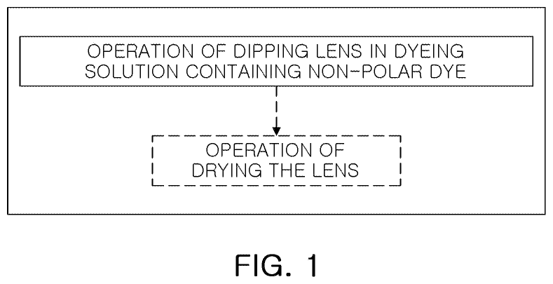

FIG. 1 is a flowchart schematically illustrating an example method of dyeing a lens, in accordance with one or more embodiments.

A method of dyeing a lens, in accordance with one or more embodiments, may include an operation of dipping a lens in a dyeing solution containing a non-polar dye. Accordingly, the dyeing solution may penetrate into a surface of the lens, and dye the surface of the lens, thereby forming a blocking portion that blocks light transmission on the surface of the lens.

The type of lens used in the examples is not particularly limited, and a lens that is implemented in optical devices such as, as non-limited examples, camera modules, may be used without limitation. In a non-limiting example, the lens may be a plastic resin lens including a resin component as a raw material, and the plastic resin lens may include at least one raw material of a polycarbonate resin and a polyolefin resin.

The polycarbonate resin may be a thermoplastic plastic polymer composed of a chain structure of bisphenol A and phosgene, and for example, a product of Mitsubishi Gas Chemical (MGC) of Japan may be used. A refractive index of the polycarbonate resin is not particularly limited, but may be about 1.63 to 1.68.

The polyolefin resin may include at least one of a cycloolefin polymer and a cycloolefin copolymer, and for example, a product of Mitsui Chemicals and Zeon may be used. The polyolefin resin may be formed by polymerization of a cyclic monomer such as norbornene, or the like. A refractive index of the polyolefin resin is not particularly limited, but may be about 1.52 to 1.56.

In an example, the dyeing solution contains a non-polar dye. Additionally, a solvent that dissolves the non-polar dye may be further included.

The type of non-polar dye is not particularly limited, and, as examples only, a colored or dark colored non-polar dye may be used. As a non-limited example, as a non-polar dye, at least one of a non-polar anthraquinone-based dye, a non-polar benzoquinone-based dye, a non-polar perylene-based dye, a non-polar phthalocyanine-based dye, a non-polar quinacridone-based pigment, a non-polar azo-based dye, and a non-polar diphenylmethane-based dye can be used. Additionally, as the non-polar dye, a single type of non-polar dye may be used. However, this is only an example, and a combination of two or more types of non-polar dyes may be used.

The non-polar dye may be a dye having low or non-polar polarity. Additionally, non-polar dyes can be hydrophobic. Therefore, an excellent effect for coloring a plastic resin lens containing a polycarbonate resin, a polyolefin resin, or the like as a raw material may be achieved.

The non-polar dye may contain a non-polar functional group such as an alkyl group or a phenyl group as a functional group. In this example, the non-polar dye may include only a non-polar functional group, and may not a polar functional group. However, the non-polar dye may contain some polar functional groups such as an amine group, a hydroxy group, a carboxyl group, a ketone group, and an aldehyde group, or the like, but in this example, it is preferable that there are 3 or less polar functional groups contained in the non-polar dye from the viewpoint of having a non-polar property. In an example, the non-polar dye may include a non-polar functional group, and may further include 3 or less amine groups.

In an example, the non-polar dye may be dissolved in a solvent and used. The solvent can be used without limitation as long as it can dissolve the non-polar dye. In an example, the solvent may be a non-polar solvent containing at least one component of toluene and benzene, and may be a hydrophobic organic solvent such as chloroform, which is a polar solvent.

In this example, the content of the non-polar dye to the solvent is not particularly limited, but may be 0.1 or more and 5 or less by weight, and in Examples described later, 3 weight % of the non-polar dye was used with respect to the solvent.

Temperature conditions in which the lens is dipped are also not particularly limited. However, the lens may be dipped in a dyeing solution at a temperature of 60° C. or lower, and in the Examples to be described later, the lens was dipped at about 50° C. to 55° C. or lower. In general, when a lens is dyed using a dispersion dye in which a solvent is dispersed in a dispersion medium such as water, a high temperature condition is required. However, in the examples in which a lens is dyed with a dissolving dye obtained by dissolving a non-polar dye in a solvent, the lens can be dyed even at a temperature of 60° C. or lower.

Additionally, a time period in which the lens is dipped or immersed is also not particularly limited. In an example, the lens may be immersed in a dyeing solution for a time of 30 seconds or less, and in the Examples to be described later, the lens was dipped for a time of 25 seconds. When the lens is dyed using a disperse dye, dyeing should be performed for several minutes to several tens of minutes for coloring. However, in the examples in which the lens is dyed with a dissolving dye, the lens can be dyed within a short time of 30 seconds or less.

In an example, the method of manufacturing a lens, in accordance with one or more embodiments, may further include drying the lens performed after the operation of dipping the lens in a dyeing solution containing a non-polar dye.

A drying temperature of the lens is not particularly limited, but may be performed at a temperature of 60° C. or higher and 80° C. or lower. The drying time of the lens is also not particularly limited, but may be performed for about 30 minutes.

In an example, in order to block light or control a path of light, there are examples in which a lens is dyed by dispersing a dye in a dispersion medium such as water, or the like. However, depending on a material of the lens, it may be difficult to dye with a disperse dye, and a flare or ghost phenomenon may occur because light cannot be effectively blocked. In an example, a lens containing a polyolefin resin as a raw material may be hydrophobic, and in the example of dyeing such a hydrophobic lens using a disperse dye in which a dye is dispersed in a dispersion medium, dyeing must be not only be performed at high temperature for a long time, but also there may be a problem in that it may be difficult to color the lens with the dye. Additionally, in the example of disperse dyes, in order to improve coloring efficiency, carriers such as trichlorobenzene and dichlorobenzene may be added to the dyeing solution.

In the example, by using a non-polar dye, it may not be possible to disperse the dye in a dispersant, but to dye the lens using a dissolving dye in which the dye is dissolved in a solvent. Therefore, even when dyeing is performed at a low temperature for a short time, coloring of the dye can have an excellent effect. Additionally, the light transmittance of the lens in the dyed region can be drastically lowered, and a flare and ghost phenomenon can also be prevented. Additionally, since a dissolving dye obtained by dissolving a non-polar dye in a solvent is used, coloring of the dye can have an excellent effect even when the dyeing solution does not contain a carrier.

The examples will be described in more detail through Examples and Comparative Examples below. However, the examples are not limited to the Examples described hereinafter.

### Example 1

A dye solution obtained by dissolving a cycloolefin copolymer resin lens and a non-polar anthraquinone-based dye in benzene was prepared, and a lens was dipped in the dye solution. As the non-polar anthraquinone-based dye, an anthraquinone-based dye containing an alkyl group, a phenyl group and two amine groups was used. In this example, the content of the anthraquinone-based dye with respect to benzene was 3% by weight. Additionally, dipping was performed for a time of 25 seconds at a temperature of 55° C. Next, the lens was dried for 30 minutes at a temperature of 60° C. Thereafter, the light transmittance of the lens according to Example 1 was measured.

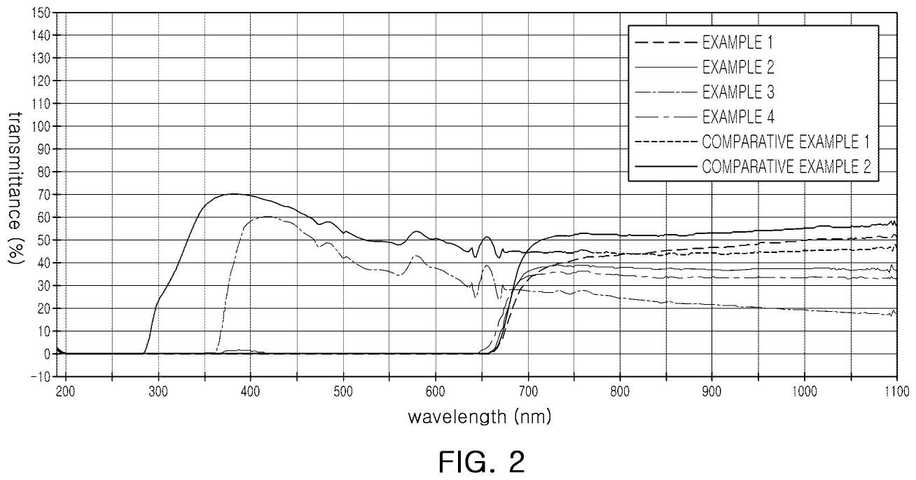

Referring to FIG. 2, it can be seen that the light transmittance of the lens according to Example 1 is close to 0% at a wavelength in the range of 190 nm to 660 nm, thereby having a very excellent light blocking rate.

### Example 2

In Example 1, toluene, not benzene, was used as a solvent to dissolve the dye. Additionally, drying was performed at a temperature of 80° C. Other conditions were applied in the same manner as in Example 1.

Referring to FIG. 2, it can be seen that the light transmittance of the lens according to Example 2 is also close to 0% at a wavelength in the range of 190 nm to 660 nm, thereby having a very excellent light blocking rate.

### Example 3

A dye solution in which a polycarbonate resin lens and a non-polar anthraquinone-based dye were dissolved in benzene was prepared, and a lens was dipped in the dye solution. As the non-polar anthraquinone-based dye, an anthraquinone-based dye containing an alkyl group, a phenyl group and two amine groups was used. In this example, the content of the anthraquinone-based dye relative to benzene was 3% by weight. Additionally, dipping was performed for a time of 25 seconds at a temperature of 55° C. Next, the lens was dried for 30 minutes at a temperature of 60° C. Thereafter, the light transmittance of the lens according to Example 3 was measured. That is, in Example 3, conditions other than the type of lens were applied in the same manner as in Example 1.

Referring to FIG. 2, it can be seen that the light transmittance of the lens according to Example 3 is also close to 0% at a wavelength in the range of 190 nm to 660 nm, thereby having a very excellent light blocking rate.

### Example 4

In Example 3, toluene, not benzene, was used as a solvent for dissolving the dye. In addition, drying was performed at a temperature of 80° C. Other conditions were applied in the same manner as in Example 3.

Referring to FIG. 2, it can be seen that the light transmittance of the lens according to Example 4 is also close to 0% at a wavelength in the range of 190 nm to 660 nm, thereby having a very excellent light blocking rate. Additionally, the light transmittance of the lens according to Example 4 was measured as being about 1% at a wavelength around 400 nm, which still corresponds to a low light transmittance value.

### Comparative Example 1

Light transmittance of the lens was measured without dyeing the cycloolefin copolymer resin lens.

Referring to FIG. 2, the light transmittance of the lens according to Comparative Example 1 at a wavelength in the range of 190 nm to 660 nm is measured as being higher than that of Examples 1 to 2 using lenses of the same material, and in particular, at a wavelength around 370 nm, it can be seen that the light transmittance soars as high as 70%.

### Comparative Example 2

Light transmittance of the lens was measured without dyeing the polycarbonate resin lens.

Referring to FIG. 2, the light transmittance of the lens according to Comparative Example 2 at a wavelength in the range of 190 nm to 660 nm is measured as being higher than that of Examples 3 to 4 using lenses of the same material, and in particular, at a wavelength around 410 nm, it can be seen that the light transmittance soars as high as about 60%.

### Comparative Example 3

A dye solution obtained by dissolving a cycloolefin copolymer resin lens and a polar anthraquinone-based dye in benzene was prepared, and a lens was dipped in the dye solution.

In the example of Comparative Example 3, it was impossible to color the dye on the surface of the lens, so it can be seen that the light transmittance was high as in the case of Comparative Example 1.

### Comparative Example 4

A dye solution obtained by dissolving a polycarbonate resin lens and a polar anthraquinone-based dye in benzene was prepared, and a lens was dipped in the dye solution.

In the example of Comparative Example 4, not only is it difficult to color the dye on the surface of the lens, but there is a side effect that the surface of the lens changes roughly in the colored region even when coloring is partially performed.

When comparing Examples and Comparative Examples with reference to Table 1, it can be seen that the lenses according to Examples 1 to 4 in the wavelength range of 190 nm to 660 nm have light transmittance close to 0%, and the light blocking rate is very excellent, compared to Comparative Examples 1 and 2. Accordingly, the method of dyeing a lens according to one or more embodiments may provide a lens that prevents a flare or ghost phenomenon.

Additionally, unlike Comparative Examples 3 and 4 in which coloring of the resin lens is impossible or difficult as a polar dye is used, it can be seen that in Examples 1 to 4, coloring is excellent.

TABLE 1

| | | | | | | | Maximum light |
|---|---|---|---|---|---|---|---|
| | | | | | Dipping | Drying | transmittance(%) |
| | | | | Weight % | condition | condition | (wavelength |
| | | | | (dye/ | (temperature/ | (temperature/ | range: 190 nm- |
| | Lens | Dye | Solvent | solvent) | time) | time) | 660 nm) |
| Example 1 | cycloolefin | non-polar | benzene | 3 | 55° C./ | 60° C./ | 0 |
| | copolymer | anthraquinone- | | | 25 sec. | 30 min. | |
| | resin lens | based dye | | | | | |
| Example 2 | cycloolefin | non-polar | toluene | 3 | 55° C./ | 80° C./ | 0 |
| | copolymer | anthraquinone- | | | 25 sec. | 30 min. | |
| | resin lens | based dye | | | | | |
| Example 3 | polycarbonate | non-polar | benzene | 3 | 55° C./ | 60° C./ | 0 |
| | resin lens | anthraquinone- | | | 25 sec. | 30 min. | |
| | | based dye | | | | | |
| Example 4 | polycarbonate | non-polar | toluene | 3 | 55° C./ | 80° C./ | 1 |
| | resin lens | anthraquinone- | | | 25 sec. | 30 min. | |
| | | based dye | | | | | |
| Comparative | cycloolefin | — | — | — | — | — | 70 |
| Example 1 | copolymer | | | | | | |
| | resin lens | | | | | | |
| Comparative | polycarbonate | — | — | — | — | — | 60 |
| Example 2 | resin lens | | | | | | |
| Comparative | cycloolefin | polar | benzene | 3 | 55° C./ | 60° C./ | — |
| Example 3 | copolymer | anthraquinone- | | | 25 sec. | 30 min. | |
| | resin lens | based dye | | | | | |
| Comparative | polycarbonate | polar | benzene | 3 | 55° C./ | 60° C./ | — |
| Example 4 | resin lens | anthraquinone- | | | 25 sec. | 30 min. | |
| | | based dye | | | | | |

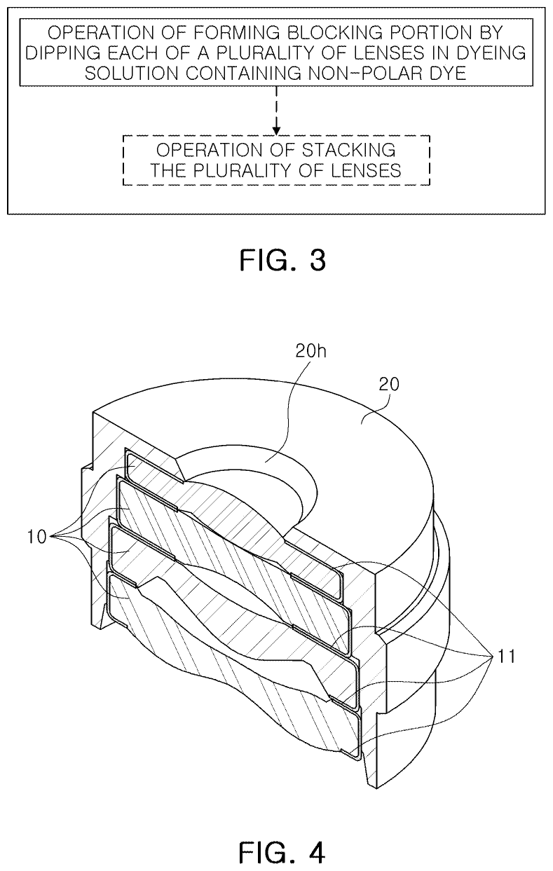

FIG. 3 is a flowchart schematically illustrating a method of manufacturing a lens assembly, in accordance with one or more embodiments.

FIG. 4 is a schematic cross-sectional view of an example lens assembly, in accordance with one or more embodiments.

Referring to FIG. 4, the lens assembly includes a plurality of lenses 10 including a blocking portion 11 and a lens barrel 20 having a lens hole 20h.

The plurality of lenses 10 may be stacked along an optical axis, and disposed in an internal space of the lens barrel 20. Each of the plurality of lenses 10 may include an effective surface and a rib surface formed to extend outwardly along an edge of the effective surface. In this example, the rib surface of each of the plurality of lenses 10 may contact a rib surface of a lens adjacent thereto.

Additionally, each of the plurality of lenses 10 may contact an inner circumferential surface of the lens barrel 20, and a side surface of each of the plurality of lenses 10 may contact the inner circumferential surface of the lens barrel 20.

In an example, the number of lenses 10 is not particularly limited, and optical properties such as a refractive index, or the like, of each of the plurality of lenses 10 may be the same or may be different from each other.

The blocking portion 11 may be formed in a region in which incidence of light of each of the plurality of lenses 10 should be blocked, for example, may be formed on a rib surface of each of the plurality of lenses 10. Additionally, the blocking portion 11 may also be additionally formed on a side surface of each of the plurality of lenses 10 in contact with the inner peripheral surface of the lens barrel 20.

In the drawings, in an example, it is shown that the blocking portion 11 is formed to extend on a rib surface and a side surface of each of the plurality of lenses 10. However, this is only an example, and the blocking portion 11 may be formed only on the rib surface of each of the plurality of lenses 10, and may not be formed on the side surface thereof.

The blocking portion 11 may be formed in a region in which incidence of light of each of the plurality of lenses 10 is to be blocked, and a region, in which the blocking portion 11 is formed, is not limited to the region shown in the drawing.

The lens barrel 20 may have a cylindrical shape in which a hollow portion is formed, and a lens hole 20h for light transmission may be formed in one surface of the lens barrel 20.

In an example, when strong light is incident on the lens 10 of the lens assembly at a certain angle, a problem in which light at a specific angle causes internal reflection from the rib surface of the lens 10 may occur. Such light is light that is not related to image formation and may cause a flare or ghost phenomenon on a screen.

Accordingly, in the examples, by dipping the lens 10 in a dyeing solution containing a dye and dyeing the lens 10, a blocking portion 11 may be formed in a region in which light incident at a certain angle is blocked to block the incidence of unnecessary light. Thereby, a method of manufacturing a lens assembly including a lens 10 that prevents a flare or ghost phenomenon may be provided. Additionally, by using a non-polar dye as a dye, a method of manufacturing a lens assembly including a lens 10 that is excellent in dye coloring and that colors the dye for a short time at a low temperature, may be provided.

Referring to FIG. 3, a method of manufacturing a lens assembly, in accordance with one or more embodiments, includes operations of forming a blocking portion 11 by dipping each of a plurality of lenses 10 in a dyeing solution containing a non-polar dye, and stacking the plurality of lenses 10. In this example, the plurality of lenses 10 may be stacked in an internal space of the lens barrel 20.

As described above, the rib surface of each of the adjacent lenses may be in contact with each other, and in the operation of forming the blocking portion 11 by dipping each of the plurality of lenses 10 in a dyeing solution containing a non-polar dye, the blocking portion 11 may be formed on the rib surface of each of the plurality of lenses 10.

Additionally, each of the plurality of lenses 10 may be disposed in the internal space of the lens barrel 20 to contact the inner circumferential surface of the lens barrel 20. In this example, in the operation of forming the blocking portion 11 by dipping each of the plurality of lenses 10 in a dyeing solution containing a non-polar dye, the blocking portion 11 may also be formed in a region that contacts the inner peripheral surface of the lens barrel 20 of each of the plurality of lenses 10. Accordingly, the blocking portion 11 may be continuously formed on the rib surface of the lens 10, in contact with the adjacent lens 10 and the side surface of the lens 10.

A detailed description of the operation of forming the blocking portion 11 by dipping each of the plurality of lenses 10 in a dyeing solution containing a non-polar dye can be applied substantially the same as the method of dyeing a lens described above, detailed description will be omitted. In this example, the operation of forming the blocking portion 11 by dipping each of the plurality of lenses 10 in a dyeing solution containing a non-polar dye may further including an operation of drying each of the plurality of lenses, similar to the method of dyeing a lens described above.

Meanwhile, as described above, in the case of the present disclosure, it may not be possible to disperse a dye in a dispersant by using a non-polar dye, but to perform the dyeing operation by using a dissolving dye in which the dye is dissolved in a solvent. Therefore, even when the dyeing operation is performed at a low temperature for a short time, coloring of the dye can be excellent. Additionally, the light transmittance of the lens in the dyed region can be significantly lowered, and a flare and ghost phenomenon can also be prevented. Additionally, since a dissolving dye obtained by dissolving a non-polar dye in a solvent is used, coloring can have an excellent effect even when the dyeing solution does not contain a carrier.

As set forth above, according to an example, a method of dyeing a lens and a method of manufacturing a lens assembly may prevent a flare or ghost phenomenon.

The method of dyeing a lens and the method of manufacturing a lens assembly according to an example may have an excellent effect of coloring with a dye.

The method of dyeing a lens and the method of manufacturing a lens assembly according to an example may have an effect of allowing a lens to be colored with a dye for a short time at a low temperature.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. A method of dyeing a lens, the method comprising:
dipping one or more lens in a dyeing solution containing a non-polar dye.

2. The method of claim 1, wherein the non-polar dye comprises a non-polar anthraquinone-based dye.

3. The method of claim 1, wherein the one or more lens comprises at least one raw material selected from a polycarbonate resin and a polyolefin resin.

4. The method of claim 1, wherein the dyeing solution further comprises a solvent that dissolves the non-polar dye,
wherein the solvent further comprises at least one of benzene, toluene and chloroform.

5. The method of claim 4, wherein a content of the non-polar dye for the solvent is 0.1 or more and 5 or less by weight %.

6. The method of claim 1, wherein the dipping of the lens in the dyeing solution containing the non-polar dye is performed at a temperature of 60° C. or lower.

7. The method of claim 1, wherein the dipping of the lens in the dyeing solution containing the non-polar dye is performed for a time of 30 seconds or less.

8. The method of claim 1, further comprising an operation of drying the lens after the dipping of the one or more lens in the dyeing solution containing the non-polar dye.

9. The method of claim 2, wherein the non-polar anthraquinone-based dye comprises three or less amine groups.

10. A method of manufacturing a lens assembly, the method comprising:
forming a blocking portion by dipping each of a plurality of lenses in a dyeing solution containing a non-polar dye; and
stacking the plurality of lenses.

11. The method of claim 10, wherein, in the forming of the blocking portion by dipping each of the plurality of lenses in the dyeing solution containing the non-polar dye, the blocking portion is formed on a rib surface of each of the plurality of lenses, and
wherein, in the stacking of the plurality of lenses, the rib surface of each of the lenses, adjacent to each other, is in contact with each other.

12. The method of claim 11, wherein, in the stacking of the plurality of lenses, the plurality of lenses are stacked in an internal space of a lens barrel such that each of the plurality of lenses is in contact with an inner circumferential surface of the lens barrel, and
wherein, in the forming of the blocking portion by dipping each of the plurality of lenses in the dyeing solution containing the non-polar dye, the blocking portion is further formed on a surface of each of the plurality of lenses, in contact with the inner circumferential surface of the lens barrel.

13. The method of claim 10, wherein the non-polar dye comprises a non-polar anthraquinone-based dye.

14. The method of claim 10, wherein the lens comprises at least one raw material selected from a polycarbonate resin and a polyolefin resin.

15. The method of claim 10, wherein the dyeing solution further comprises a solvent that dissolves the non-polar dye, and
wherein the solvent further comprises at least one of benzene, toluene and chloroform.

16. The method of claim 13, wherein the non-polar anthraquinone-based dye comprises 3 or less amine groups.

17. The method of claim 1, wherein the dyeing solution contains a dissolvable non-polar dye.

18. The method of claim 10, wherein the dyeing solution contains a dissolvable non-polar dye.
